(19) United States
(12) Patent Application Publication
(10) Pub. No.: US 2007/0174409 A1
(43) Pub. Date: Jul. 26, 2007

(54) Dynamic network fusion in wireless ad-hoc networks

(75) Inventors: Thomas Falck, Aachen (DE); Javier Espina Perez, Aachen (DE); Henning Maass, Aachen (DE); Klaus Weidenhaupt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,260

(22) PCT Filed: Feb. 25, 2005
(86) PCT No.: PCT/IB05/50692

§ 371 Date: Aug. 23, 2006

(30) Foreign Application Priority Data
Mar. 8, 2004 (EP) 04100923.4

(51) Int. Cl. G06F 15/16

(52) U.S. Cl. 709/208

(57) ABSTRACT

The invention relates to networks having at least one slave terminal or device, and a master terminal or device connected thereto that controls the network and is arranged to instruct at least one slave terminal or device to exchange sub-network information with at least one other sub-network. On receipt of an inquiry, a slave terminal or device in another sub-networks transmits a response to the inquiring slave terminal or device in the first sub-network. The communicating slave terminals or devices pass on the sub-network information that is exchanged to the master terminal or device, for the responding sub-network to be merged into the inquiring sub network.

The invention relates to networks having at least one slave terminal or device and a master terminal or device connected thereto. Such networks may for example comprise terminals or devices that operate to the Bluetooth standard.

The Bluetooth standard was originally developed to allow wireless communication between a wide variety of different terminals or devices over short ranges. Only with time did a demand arise for Bluetooth terminals or devices to be networked, for so-called ad-hoc networks to be set up. However, a problem that is posed in this case is how a Bluetooth network involving a plurality of users is to be set up, because the Bluetooth specification does not make any stipulations in this respect. In the document entitled “Bluetooth SIG, PAN Working Group, Personal Area Networking Profile, Version 1.0, Jul. 23, 2002, pages 10 to 12” there is for example a description of how a network is to be set up under the Bluetooth standard. It is stated in this case that the setting up of a network is only performed manually, e.g. no proposals are made as to the manner in which terminals or devices will interconnect themselves automatically to form networks. Nor are any proposals made as to how a plurality of existing sub-networks are to connect up with one another automatically to form a network.

It is an object of the invention to provide a network that automatically allows a further sub-network to be merged in.

This object is achieved by networks of the kind specified in the opening paragraph, by virtue of the making of the following provisions:

The sub-networks have at least one slave terminal or device, and a master terminal or device connected thereto that is arranged to instruct at least one slave terminal or device in the given sub-network to exchange sub-network information with other sub-networks, an inquiring or responding state being provided for a slave terminal or device that has been instructed to exchange information, the master terminal or device of a responding slave terminal or device being arranged to dissolve its sub-network, and the master terminal or device of an inquiring slave terminal or device being arranged to merge the terminals or devices of the dissolved sub-network into its own sub-network.

In accordance with the invention, it is not the master terminal or device that engages in the exchange of sub-network information with other sub-networks but a slave terminal or device that is instructed to do so by it. The information exchanged also includes information on whether the slave terminal or device taking part in the communication is merged in a sub-network. In this way, the master terminal or device is able to concern itself largely with communications on its own network. Once a different sub-network has responded to an inquiry from a slave terminal or device, this response is passed on to the master terminal or device, which begins to establish the connection to the terminals or devices in the other sub-network, which by now has been dissolved, of whose addresses it was notified beforehand by the responding slave terminal or device. Under claim 3, each terminal or device in a sub-network is notified by its own master terminal or device of all the addresses of all the terminals or devices merged in the sub-network. In this way, it is possible for a sub-network to be completely merged into some other sub-network at any time. The merging-in of terminals or devices takes place under given conditions, as specified in claim 4. One condition may for example be that a terminal or device has not been connected to the network previously. Compliance with the conditions in question may be checked by means of a blacklist managed by the master terminal or device, as specified in claim 5.

Provision is also made in accordance with the invention, as detailed in claim 6, for only one slave terminal or device in a sub-network to attempt to exchange information with other sub-networks and for the other terminals or devices in the same sub-network not to transmit responses or inquiries. This prevents a sub-network from being discovered more than once by another sub-network, or from revealing itself, more than once.

The network according to the invention can be set up from terminals or devices that operate to the Bluetooth standard. The construction of the software components intended for this purpose is described in claim 7.

To ensure that communications on the network are not disrupted unnecessarily, the master terminal or device is arranged to give instructions for the exchange of sub-network information to only a single slave terminal or device that is not participating in communications.

The invention also relates to sub-networks that are arranged to be dissolved and merged into another sub-network, and to sub-networks that are arranged to merge in terminals or devices from a dissolved sub-network.

The invention also relates to a terminal or device that is arranged to be a slave or a master terminal or device for merging into a sub-network, a master terminal or device being arranged to notify all the terminals or devices merged in its own network of the addresses of all the terminals or devices merged in its said own network, and to give instructions to slave terminals or devices to exchange sub-network information with other sub-networks, and a slave terminal or device that is given instructions being arranged for an inquiring or a responding state and to pass on the sub-network information received to its own master terminal or device, the master terminal or device of a responding slave terminal or device being arranged to dissolve its own sub-network while the master terminal or device of an inquiring slave terminal or device is arranged to merge in the terminals or devices from the dissolved sub-network, and a slave terminal or device that has no instructions from the master terminal or device to exchange sub-network information, being arranged not to make inquiries or to respond to inquiries from a terminal or device.

These and other aspects of the invention are apparent from and will be elucidated with reference to the embodiments described hereinafter.

In the drawings:

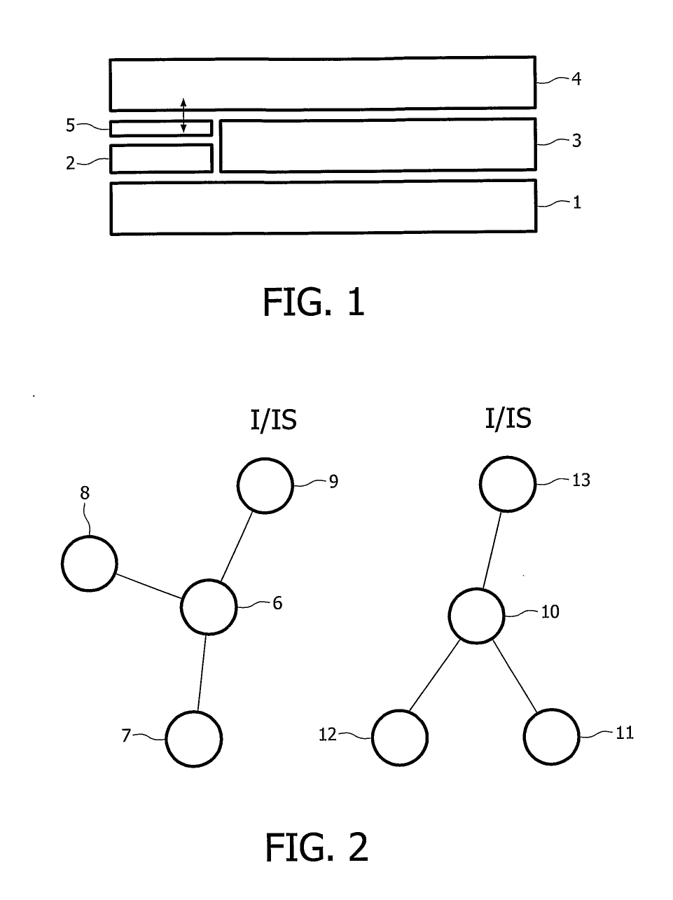

FIG. 1 is a highly simplified layer model of the software components contained in a terminal or device.

FIGS. 2 to 5 show the process of connecting two sub-networks each having one master terminal or device and a plurality of slave terminals or devices to form a single network, and

FIG. 6 is a state diagram to elucidate the software components according to the invention.

Bluetooth is a communications standard for wireless radio communication that is intended to make the exchange of data possible between any conceivable types of terminal or device. Whether they are notebooks, organizers, mobile telephones or computer peripheral, Bluetooth is intended to give terminals or devices of every sort the ability to communicate with one another. The terminals or devices on a Bluetooth network operate on 79 channels each with a bandwidth of 1 MHz in the 2.45 GHz frequency range. In communication, it is not one and the same channel that is used all the time and instead frequency is changed 1600 times a second (frequency hopping) to cancel out interference with other devices. This is necessary because the frequency band used is freely available. The useful data is transmitted on a packet basis and to meet user requirements, different types of packet are defined. These differ by whether they are for synchronous or asynchronous operation and they are identified by an entry in the header.

Essential characteristics of a Bluetooth device are firstly a clock rate of its own, which lays down the rate at which the frequency hops are made, and also a unique Bluetooth device address. This latter then also gives the identity of the device, which specifies the different frequencies in the hopping sequence.

When two Bluetooth terminals or devices are connected, one assumes the role of master terminal or device and the other the role of slave terminal or device. What has to be borne in mind in this case is that there is no such thing as predetermined master or slave terminals or devices and instead the allocation of roles takes place dynamically when the connection is being established. The master terminal or device lays down a binding hopping sequence for the slave terminal or device, i.e. the hops between the frequencies, and allocates transmitting rights.

When a connection is being established, the process progresses through two phases. The first phase is designated the inquiry phase and is used when a search is to be made for as yet undiscovered terminals or devices or sub-networks on which no information whatever is available as yet. For as long as there is no connection, a terminal or device alternates constantly between the inquiry and the inquiry scan states. In the inquiry state the terminal or device hops between 32 frequencies and emits its inquiry. In the inquiry scan state it likewise hops between 32 frequencies and searches or scans for an inquiry message. If a terminal or device in the inquiry scan state receives such an inquiry, it responds by transmitting at least its address and its clock rate, and the exchange of information can begin.

The second phase of the establishment of a connection is designated the page phase. In this phase, one terminal or device changes to the page state and the other terminal or device to the page scan state. The allocation of roles is laid down in such a way in this case that the inquiring terminal or device becomes the master terminal or device or the inquiring sub-network remains in existence, and the responding terminal or device or sub-network become a slave terminal or device or slave terminals or devices. A prerequisite is that the Bluetooth device addresses of the slave terminals or devices are known to the master terminal or device. The page phase can be speeded up if the master terminal or device has available to it not only the addresses of the particular slave terminals or devices but also their clock rates. The master terminal or device transmits its own clock rate and hopping sequence to the slave terminal or device and directs it to adopt these. The slave terminal or device then synchronizes itself with the master terminal or device and in this way is able to communicate with it.

Packets of data are transmitted between the individual terminals or devices and apart from the useful data they also contain additional pieces of information such as, for example, the transmitter and receiver addresses, transmission options, synchronizing information and, where required, securing information and additional redundancies. A packet of this kind comprises a 72-bit access code, a 54-bit header and a useful-data field whose length varies from 0 to 2745 bits. What is used for the inquiry phase is for example an ID packet that contains the address of the terminal or device. The current Bluetooth standard still has some bits reserved in this field that are not so far being used for anything. A reserved bit in this field can be used to state whether a terminal or device is connected to a network. In what follows, this reserved bit will be referred to as a connection bit. If a terminal or device is already merged into a network (connected), this connection bit is set to logic “1” and if not, it is set to logic “0”. Another packet is the FHS (frequency hopping synchronization) packet, which is used, when a connection is being established, to transmit, amongst other things, clock rate information, the addresses of all the terminals or devices in the sub-network, the phase of the hopping sequence, and the name of the class of service (what type of device the one involved is).

Bluetooth networks can be implemented with point-to-point, piconet and scatternet topologies. These network topologies open up a large number of possible applications that may be conceived of. A piconet comprises a master terminal or device and up to seven active slave terminals or devices. In principle, a master terminal or device can control more than seven slave terminals or devices by sending some of the slave terminals or devices into a sort of sleep mode. Basically, communication takes place in this case solely through the master terminal or device, which allocates transmission rights and lays down the frequencies to be used. The master terminal or device allocates transmission rights alternately to the individual slave terminals or devices.

Because of the use of frequency hopping, it is possible for a plurality of piconets, which are also referred to here as sub-networks, to exist side by side with one another. A terminal or device could even be a member of a plurality of piconets in this case. For this purpose, the terminal or device would simply store the hopping sequences of all the master terminals or devices of whose networks it was a member and in this way would be able to set itself to the frequency of any network. A terminal or device of this kind would be designated a bridge node because it would represent as it were a bridge between the piconets. A plurality of piconets connected in this way would form a scatternet. The current Bluetooth standard does not support scatternets however.

Originally, the Bluetooth standard was developed to make possible wireless communication between a wide variety of different terminals or devices over short ranges. Only with time did the demand arise for Bluetooth terminals to be networked and for so-called ad-hoc networks to be set up. There may for example be a number of groups of people who have Bluetooth terminals and are participating in a conference in a room. Each group forms a sub-network of its own. Should these groups wish to exchange their data with one other, each participant would execute a command of the “Establish connection with ad-hoc network” type and after a short time would receive a message “Connection to ad-hoc network established” and could then begin to exchange data with any desired other participant. When this happens however, the problem arises of how a Bluetooth network composed of a plurality of sub-networks is going to be set up quickly and automatically without the participants (i.e. users) having to do anything, because the Bluetooth specification does not make any stipulations in this respect.

In accordance with the invention, a terminal contains a software component that is designated a “dynamic personal area network manager” (referred to below as DPM software) and that cooperates with the Bluetooth software proper and the application software in the particular case and is arranged to set up and control an ad-hoc network. A highly simplified layer model of the software components is shown in FIG. 1. Arranged above the layer 1, which represents the Bluetooth software (the first software component), is the layer 2 having the DPM software (the second software component), and software 3 provided for the internet protocol. In the top layer 4 is situated application software that, via a software interface 5 (referred to below as DPM-API software) starts, controls and stops the DPM software.

When an ad-hoc network is being formed from at least two sub-networks, the terminals or devices affected execute a network set-up procedure that is described below. The first step in an automatic ad-hoc network setting-up operation according to the invention is an automatic detection of terminals or devices belonging to another sub-network (the inquiry phase). Before a network setting-up operation starts, the terminals or devices have to gather information on their environment independently of one another. Each sub-network can set up an ad-hoc network independently by going into the inquiry and inquiry scan states described above to exchange information with another sub-network. The time of switching between the two states has to be selected randomly in this case. If another network has been found, the inquiry phase is stopped and a connection is established to the sub-network that has been detected (the page phase). A new network has thus been produced spontaneously and automatically from two sub-networks without the user of a device having to do anything. At a point in time no later than the completion of the merging of all the terminals or devices in the one sub-network into the other sub-network, the master terminal or device notifies all the terminals or devices that have been merged into the network of the addresses of all the terminals or devices of said merged or fused network. Any further sub-network can be merged into the network described above by re-applying the merging-in procedure that is described below. In particular, this procedure does not require a Bluetooth standard that supports scatternets.

In accordance with the invention, a master terminal or device selects, in a given sequence, a slave terminal or device connected to it, to enable information to be exchanged with other terminals or devices. When this happens, the slave terminal or device to which instructions have been given changes to the inquiry state and then to the inquiry scan state. Because a change to the inquiry or inquiry scan state has a disruptive effect on communications within a network, the disruptions that the changes of state involve are minimized by minimizing the number of slave terminals or devices that are instructed to make this change of state. A high quality of service within the sub-networks is obtained by virtue of the fact that the master terminal or device is never in the inquiry or inquiry scan states and, this being the case, is available for communications within the network.

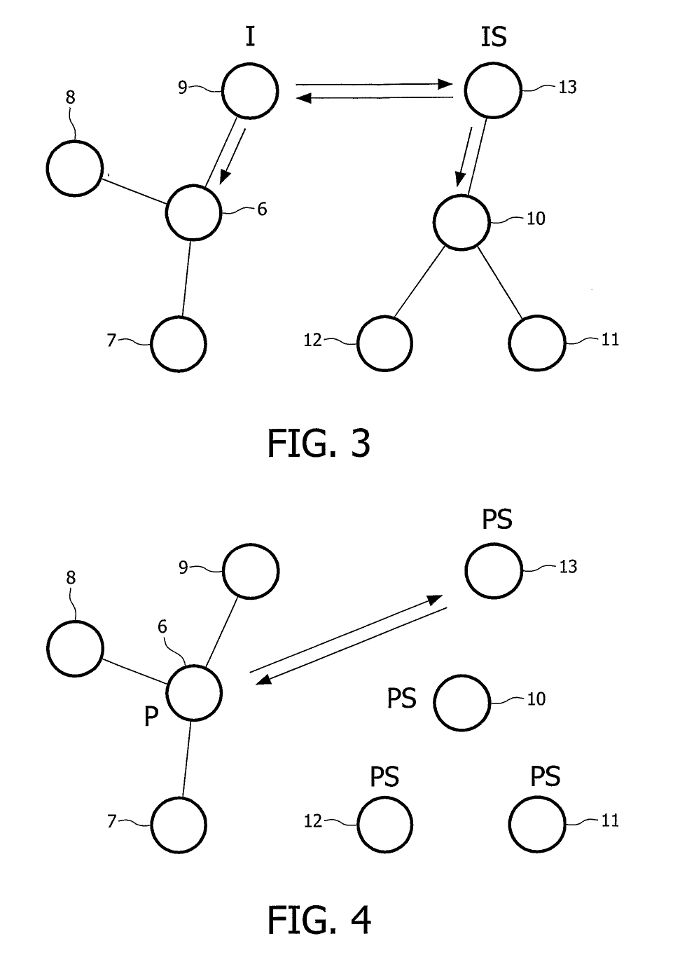

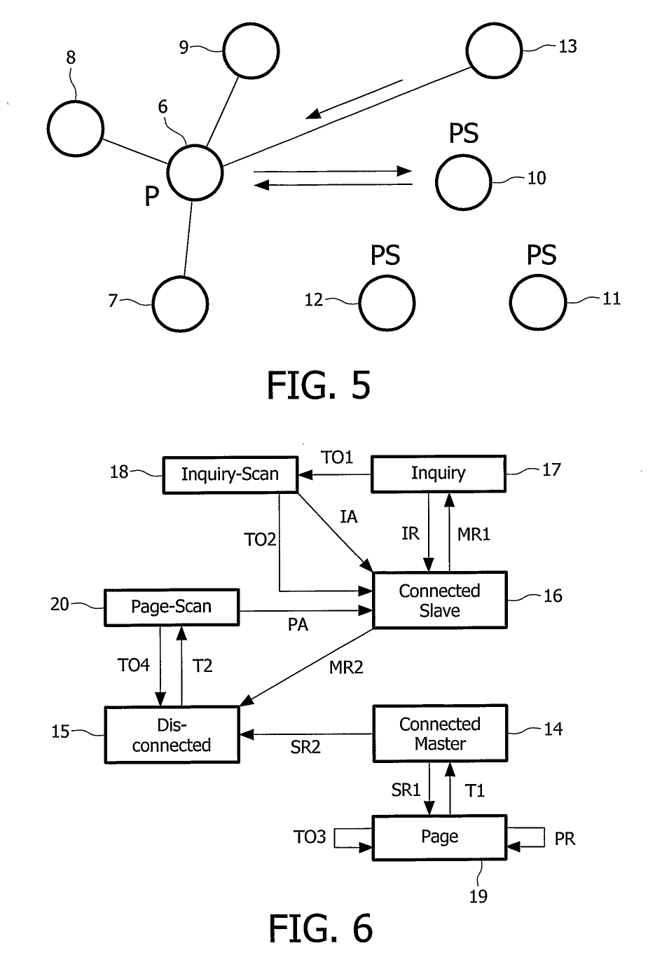

The merging-in of a further sub-network can be explained as the result of the following steps and will be elucidated by means of FIGS. 2 to 6. FIG. 2 shows two sub-networks, with the first sub-network comprising a master terminal or device 6 and three slave terminals or devices 7 to 9 connected thereto, and with the other sub-network likewise comprising a master terminal or device 10 and three terminals or devices 11 to 13 connected thereto. The master terminals have each instructed a slave terminal (terminal 9 in the first sub-network and terminal 13 in the second sub-network) to exchange information with other sub-networks, which information also includes information on membership of a network (connection bit set to logic “1”=merged into network or logic “0” not merged into network). For this purpose, the slave terminals or devices 9 and 13 change, cyclically, to the inquiry (I) and inquiry scan (IS) states, with the time of the changeover between the two states being randomly selected. If, as shown in FIG. 3, two sub-networks have approached sufficiently close to one another, and if the slave terminals that have been instructed to exchange information are in the inquiry state in the first sub-network (terminal 9) and in the inquiry scan state in the second sub-network (terminal 13), then terminal 13 responds to the inquiry from terminal 9 with a packet (ID packet) that contains at least the address of terminal 13. The response may also contain a plurality of the addresses, or all the addresses, of the terminals or devices in the responding sub-network. Both the slave terminals or devices 9 and 13 then inform their master terminals or devices 6 and 10 about the information that has been exchanged. The master terminal or device 10 connected to the slave terminal or device 13 receives the information that the slave terminal or device 9 is merged into another network and is in the inquiry state. As shown in FIG. 4, the master terminal or device 10 therefore directs all the slave terminals or devices in its own sub-network to go to the page scan state, dissolves its own sub-network and then itself goes over to the page scan state to be merged into the other sub-network. The master terminal or device 6 connected to the slave terminal or device 9 receives the information that the slave terminal or device 13 is merged into another network and is in the inquiry scan state. As shown in FIG. 4, the master terminal or device 6 goes over to the page state to merge the terminals or devices in the other sub-network into its own sub-network. As shown in FIG. 5, the master terminal or device 6 establishes a connection to the terminal or device 13, whose address is known to the master terminal or device as a result of the communication of the slave terminals or devices 9 and 13 with one another and, on receiving the FHS packet, merges the terminal or device into its network. At this point in time at the latest, the terminal or device 13 that has been merged in transmits the addresses of terminals or devices 10 to 12 to the master terminal or device. The terminals or devices, whose addresses are known to the master terminal or device 6, are now merged into its network by the master terminal or device 6. Once the address list of the dissolved sub-network has been worked through, the larger network that has now come into being comprises the master terminal or device 6 and the slave terminals or devices 7 to 13. At this point at the latest, the master terminal or device notifies the merged slave terminals or devices 7 to 13 of the addresses of all the terminals 6 to 13 that are in the merged or fused network.

The master terminal 6 then directs the next slave terminal or device (e.g. slave terminal 7) to exchange information with other networks. In a given sequence, the master terminal or device instructs the slave terminals or devices to go to the inquiry and inquiry scan states. The form the given sequence takes may for example be that all the slave terminals or devices go to these states in succession for a time that is preset to be the same for each of them.

The operation of the DPM software that controls the process described above can be explained by reference to the state diagram shown in FIG. 6. The DPM software has a total of seven states, which are represented in FIG. 6 by the rectangles 14 to 20. As a result of an instruction from the master terminal or device, a slave terminal or device goes (arrow MR1) from the Connected Slave state (rectangle 16) to the Inquiry state (rectangle 17). If, within a randomly selected period of time, it receives a response from another terminal or device then, after an exchange of information with the responding terminal or device, it goes (arrow IR) to the Connected Slave state (rectangle 16). If the terminal or device that is in the Inquiry state (rectangle 17) does not receive a response during the period of time mentioned, it goes (arrow TO1) to the Inquiry scan state (rectangle 18). If, even while in this state, it does not receive an inquiry from another terminal within a randomly selected period of time, the terminal or device goes (arrow TO2) to the Connected Slave state (rectangle 16). If on the other hand it receives an inquiry while in the Inquiry scan state (rectangle 18) then, after responding to the inquiry, it goes (arrow IA) to the Connected Slave state (rectangle 16). The terminal or device informs its own master terminal about the changes of state (arrows IR, IA or TO2) that are carried out as a function of the situation.

If a slave terminal or device has gone over to the Connected Slave state as indicated by arrow TO2, the master terminal or device instructs a different slave terminal or device to repeat the process described above.

If a slave terminal or device has gone over to the Connected Slave state (rectangle 16) as indicated by arrow IA, its own master terminal or device prepares to dissolve the network by directing all the slave terminals or devices to go (arrow MR2) from the Connected Slave state (rectangle 16) to the Disconnected state (rectangle 15) and then (arrow T2) to the Page Scan state (rectangle 20). The master terminal or device itself then goes (arrow SR2) from the Connected Master (rectangle 14) state to the Disconnected state (rectangle 15) and then changes (arrow T2) to the Page Scan state (rectangle 20). If, within a given period of time, no merging-in has taken place into a network, the terminals or devices go (arrow TO4) from the Page Scan state (rectangle 20) to the Disconnected state (rectangle 15).

If a slave terminal or device has gone into the Connected Slave state (rectangle 16) as indicated by arrow IR, it notifies the master terminal or device of at least the network membership and address of the responding terminal or device. The master terminal or device then changes its state (arrow SR1) from Connected Master (rectangle 14) to Page (rectangle 19), in which latter state it tries to establish a connection to the terminal or device, whose response at least contained the terminal's or device's own address and which is thus known. The response may however equally well have contained a plurality of the addresses in the dissolved sub-network or all of them. If a connection is successfully established, the new terminal or device that has been merged in goes (arrow PA) from the Page Scan state (rectangle 20) to the Connected Slave state (rectangle 16) and is now part of the expanded network. At this point in time at the latest, it notifies the master terminal or device of the addresses of the other terminals or devices that were in the Page Scan state (rectangle 20) in the dissolved sub-network. If a terminal or device is successfully merged in, the master terminal or device again goes (arrow PR) to the Page state (rectangle 20) and tries to merge in the next terminal or device on the address list that was transmitted. If the merging-in is not successful, the master terminal or device goes (arrow TO3) to the Page state (rectangle 20) and tries to merge in the next terminal or device on the address list that was transmitted. Once the address list has been worked through, the master terminal or device changes back (arrow T1) from the Page state (rectangle 19) to the Connected Master state (rectangle 14).

Once the master terminal or device has notified all the slave terminals connected to it of the addresses of all the terminals or devices merged into its own network, it again instructs a slave terminal or device to exchange information with another sub-network that is not merged in. For this purpose, the slave terminal or device goes (arrow MR1) from the Connected Slave state (rectangle 16) to the Inquiry state (rectangle 17). The programmed procedure described above is then gone through again.

It should be mentioned that slave terminals or devices in an existing network that have not been instructed to exchange sub-network information never change from the Connected Slave state (rectangle 16) to the Inquiry (rectangle 17) or Inquiry Scan (rectangle 18) state. This stops a sub-network from being discovered more than once by another sub-network or a sub-network from again discovering a terminal or device that is already merged in.

To optimize the setting up of a network still further, the address of unwanted terminals or devices can be placed on a so-called blacklist by means of the DPM-API software. After the address of a terminal or device has been transmitted, or after an address list covering a plurality of terminals or devices has been transmitted, the master terminal or device checks whether the terminal or device to be merged in is included in the blacklist. If it is, the connection that has just been established is broken again or the terminal or device is ignored, i.e. no attempt is made to establish a connection to this terminal or device. Otherwise, the establishment of a connection is performed as described above.

What may be shown on the blacklist are for example terminals or devices that were merged in the network a certain length of time previously and are no longer of interest. What may also be stored on the blacklist are terminals or devices that do not offer certain services. It may for example be that a printer is being looked for for the network and all terminals or devices that do not have this printer service are therefore placed on the blacklist.

The procedure according to the invention is especially suitable for networks in which the terminals or devices are moving quickly, because it allows connections to be established quickly. The way in which this is achieved is that in an existing network a slave terminal or device constantly changes to the inquiry and inquiry scan states and in this way an active and continuous lookout is kept for new sub-networks. New sub-networks are therefore discovered and added to the existing network as quickly as is possible.

1. A network comprising at least two sub-networks, each having at least one slave terminal or device and a master terminal or device connected thereto that is arranged to instruct at least one slave terminal or device in the given sub-network to exchange sub-network information with other sub-networks,
wherein an inquiring or responding state is provided for a slave terminal or device that has been instructed to exchange information, the master terminal or device of a responding slave terminal or device being arranged to dissolve its sub-network, and the master terminal or device of an inquiring slave terminal being arranged to merge the terminals or devices of the dissolved sub-network into its own sub-network.

2. A network as claimed in claim 1, characterized in that a slave terminal that is instructed to exchange information is arranged to report its network membership.

3. A network as claimed in claim 1, characterized in that the master terminal or device is arranged to notify all the slave terminals or devices in its own sub-network of the addresses of all the terminals or devices that are merged in its own sub-network.

4. A network as claimed in claim 1, characterized in that, when establishing a connection to other terminals or devices, the master terminal or device is arranged to check compliance with conditions for merging a terminal or device as a slave terminal or device into the sub-network.

5. A network as claimed in claim 4, characterized in that the master terminal or device is arranged to merge a terminal or device as a slave terminal or device into the network provided the slave terminal or device is not included in a blacklist.

6. A network as claimed in claim 1, characterized in that a slave terminal or device participating in communications on the network that has not been instructed by the master terminal or device to exchange sub-network information is arranged not to change to a state in which it transmits inquiries or a response to an inquiry from another terminal or device.

7. A network as claimed in claim 1, characterized in that a terminal or device has a first software component that operates to the Bluetooth standard and a second software component for controlling the first software component, which second software component is arranged to convert instructions from a third, application-oriented software component, and in that the second software component is arranged for merging sub-networks.

8. A network as claimed in claim 1, characterized in that the master terminal or device is arranged to instruct only a single slave terminal or device that is not participating in communications to exchange sub-network information with other sub-networks.

9. A sub-network comprising at least one slave terminal or device, and a master terminal or device connected thereto that is arranged to instruct at least one slave terminal or device in a sub-network to exchange sub-network information with other sub-networks, wherein an inquiring or responding state is provided for a slave terminal or device that has been instructed to exchange information, the master terminal or device of a responding slave terminal or device being arranged to dissolve its sub-network, and the master terminal or device of an inquiring slave terminal or device being arranged to merge the terminals or devices of the dissolved sub-network into its own sub-network.

10. A terminal that is provided as a slave terminal or device or master terminal or device in a sub-network, wherein the terminal or device is arranged, as a master terminal or device,
to notify all the terminals or devices merged in its own sub-network of the addresses of all the terminals or devices merged in its own sub-network,
to instruct a slave terminal or device to exchange sub-network information with another sub-network
as a master terminal or device of a responding slave terminal, to dissolve its own sub-network,
as a master terminal or device of an inquiring slave terminal or device, to merge the terminals or devices from the dissolved sub-network into its own sub-network, and wherein the terminal or device is arranged, as a slave terminal or device,
to exchange sub-network information in an inquiring or responding state,
to pass on the sub-network information received to its own master terminal or device,
when not instructed by the master terminal or device to exchange sub-network information, not to inquire or to respond to inquiries from a terminal or device.
